(19) United States
(12) Patent Application Publication
(10) Pub. No.: US 2012/0042238 A1
(43) Pub. Date: Feb. 16, 2012

(54) EMBEDDED DEVICE AND THREE-DIMENSIONAL USER INTERFACE REALIZATION METHOD

(75) Inventors: TZU-YU LEE, Tu-Cheng (TW); PO-TING KUO, Tu-Cheng (TW); CHIA-WEI LIAO, Tu-Cheng (TW)

(73) Assignee: HON HAI PRECISION INDUSTRY CO., LTD., Tu-Cheng (TW)

(21) Appl. No.: 12/882,149

(22) Filed: Sep. 14, 2010

(30) Foreign Application Priority Data
Aug. 10, 2010 (CN) 201010249714.8

(51) Int. Cl. G06F 17/00

(52) U.S. Cl. 715/237

(57) ABSTRACT

A three-dimensional (3D) user interface in an embedded device supports programming languages which are supported by the X3D standard, and may embed an extensible 3D (X3D) file into a hypertext mark-up language (HTML) file using one of the programming language. Then the X3D file in the HTML file is parsed by a browser plug-in of the 3D user interface, and an open graphics library (Open GL) is converted to an open graphics library for embedded systems (Open GL ES). Furthermore, corresponding functions in the Open GL ES are executed according to the parsing results, to render a 3D scene defined by the X3D file in the HTML file. In addition, the HTML file and the 3D scene is output on a display of the embedded device.

### BACKGROUND

1. Technical Field

Embodiments of the present disclosure relates to application interfaces, and more particularly, to an embedded device and a three-dimensional (3D) user interface realization method in the embedded device.

2. Description of Related Art

Extensible three-dimensional (X3D) is the international organization for standardization (ISO) standard extensible markup language (XML)-based file format for representing 3D computer graphics, the successor to the virtual reality modeling language (VRML). On one hand, X3D is widely used for rendering virtual 3D scenes in computers. On the other hand, embedded devices, such as mobile phones, personal digital assistants, and set-top boxes, are widely used by people. What is desired, therefore, is a user interface for realizing rendering virtual 3D scenes in the embedded devices uses the X3D standard.

### BRIEF DESCRIPTION OF THE DRAWINGS

FIG. 1 is a block diagram of one embodiment of an embedded device including a three-dimensional (3D) user interface.

FIG. 2 is a block diagram of one embodiment of function modules of the 3D user interface in FIG. 1.

FIG. 3 is a flowchart of one embodiment of a 3D user interface realization method in the embedded device in FIG. 1.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

In general, the word “module,” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

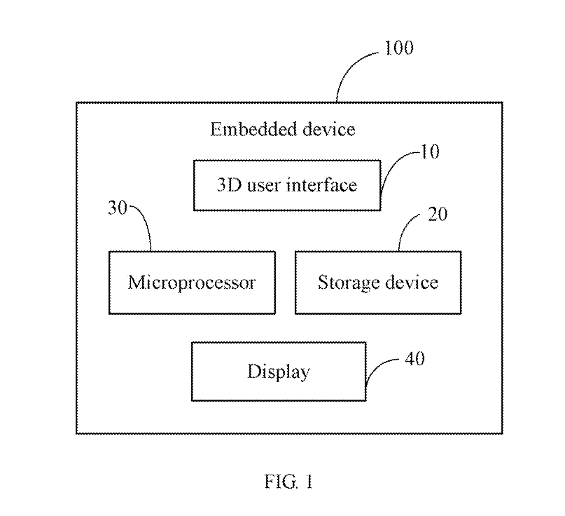

FIG. 1 is a block diagram of one embodiment of an embedded device 100. Depending on the embodiment, the embedded device 100 may be a mobile phone, a personal digital assistant, a set-top box or any other suitable embedded device. In this embodiment, the embedded device 100 includes a three-dimensional (3D) user interface 10, a storage device 20, a microprocessor 30, and a display 40. One or more computerized codes of the 3D user interface 10 are stored in the storage device 20, where the microprocessor 30 executes the one or more computerized codes, to provide a function of rendering a 3D scene in the embedded device 100 using an extensible 3D (X3D) file. Depending on the embodiment, the storage device 20 may be a smart media card, a secure digital card, or a compact flash card. The display 40 displays the 3D scene to users.

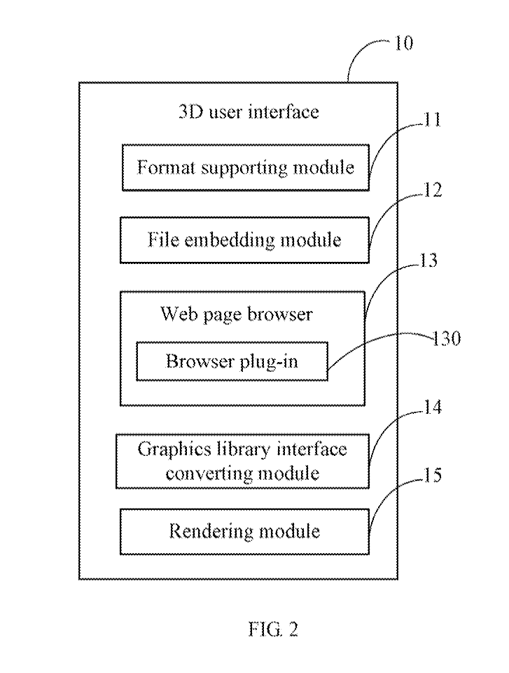

FIG. 2 is a block diagram of one embodiment of function modules of the 3D user interface 10 in FIG. 1. In one embodiment, the 3D user interface 10 includes a format supporting module 11, a file embedding module 12, a Web page browser 13, a graphics library interface converting module 14, and a rendering module 15. The Web page browser 13 includes a browser plug-in 130.

The format supporting module 11 sets programming languages supported by the 3D user interface 10. In this embodiment, the 3D user interface 10 supports programming languages, such as virtual reality modeling language (VRML), extensible markup language (XML), JavaScript, Java, and Java3D, which are supported by the X3D standard.

The file embedding module 12 obtains an X3D file created by a user, and uses a programming language, which is supported by the 3D user interface 10 and selected by the user, to embed the X3D file into a hypertext mark-up language (HTML) file. The X3D file, which defines the 3D scene to be rendered, may be a file having a suffix such as “.wrl,” “.x3d,” or “.x3dv.” 3D model tools, such as MAYA, Blender, and AC3D, can be used to create the X3D file. In this embodiment, the X3D file is stored in the storage device 20.

The browser plug-in 130 parses the X3D file in the HTML file. For example, the browser plug-in 130 performs a syntax check to the X3D file, and converts a statement format of the X3D file to a statement format that can be identified by the Web page browser 13. For example, the browser plug-in 130 adds a pair of element tags with a “start tag” and an “end tag” to each statement in the X3D file, where a tag is a keyword enclosed in angle brackets, so that each statement in the X3D file is converted to a HTML element, such as “<tag>content to be rendered</tag>.”

The graphics library interface converting module 14 converts an open graphics library (Open GL) to an open graphics library for embedded systems (Open GL ES). The Open GL is a standard specification defining a cross-language, cross-platform application programming interface for writing applications that produce 2D and 3D computer graphics. The Open GL consists of over 250 different function calls which can be used to draw complex three-dimensional scenes from simple primitives. In this embodiment, the conversion includes deleting some functions in the Open GL, such as functions for drawing quadrilaterals and polygons, to create a flexible and powerful low-level 3D user interface 10 between software and graphics acceleration in the embedded device 100. Therefore, the Open GL ES is a subset of the Open GL.

The rendering module 15 executes corresponding functions in the Open GL ES according to the parsing results from the browser plug-in 130, to render the 3D scene defined by the X3D file in the HTML file. Then the Web page browser 13 displays the HTML file with the 3D scene on the display 40.

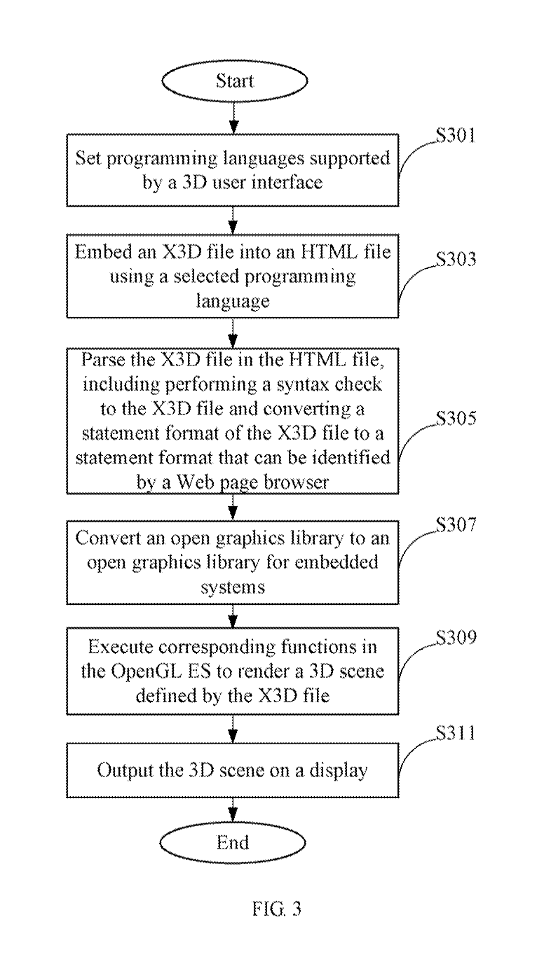

FIG. 3 is a flowchart of one embodiment of a 3D user interface realization method in the embedded device in FIG. 1. Depending on the embodiment, additional blocks may be added, others removed, and the ordering of the blocks may be changed.

In block S301, the format supporting module 11 sets programming languages supported by the 3D user interface 10. As mentioned above, the format supporting module 11 sets the programming languages, such as VRML, XML, JavaScript, Java, and Java3D, which are supported by the X3D standard to be supported by the 3D user interface 10.

In block S303, the file embedding module 12 obtains an X3D file from the storage device 20, and embeds the X3D file into a HTML file using a programming language, which is supported by the 3D user interface 10 and selected by the user. The X3D file, which defines the 3D scene to be rendered, may be a file having a suffix such as “.wrl,” “.x3d,” or “.x3dv.” 3D model tools, such as MAYA, Blender, and AC3D, can be used to create the X3D file.

In block S305, the browser plug-in 130 parses the X3D file in the HTML file. In this embodiment, the browser plug-in 130 performs a syntax check to the X3D file, and converts a statement format of the X3D file to a statement format that can be identified by the Web page browser 13. For example, the browser plug-in 130 adds a pair of element tags with a “start tag” and an “end tag” to each statement in the X3D file, where a tag is a keyword enclosed in angle brackets, so that each statement in the X3D file is converted to a HTML element, such as “<tag>content to be rendered</tag>.”

In block S307, the graphics library interface converting module 14 converts the Open GL to the Open GL ES. As mentioned above, the Open GL ES is a subset of the Open GL. The conversion includes deleting some functions in the Open GL, such as functions for drawing quadrilaterals and polygons, to create a flexible and powerful low-level 3D user interface 10 between software and graphics acceleration in the embedded device 100.

In block S309, the render module 15 executes corresponding functions in the Open GL ES according to parsing results from the browser plug-in 130, to render the 3D scene defined by the X3D file in the HTML file.

In block S311, the Web page browser 13 displays the HTML file with the 3D scene on the display 40.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An embedded device, comprising:
a storage device;
at least one microprocessor; and
a three-dimensional (3D) user interface comprising one or more computerized codes, which are stored in the storage device and executable by the at least one processor, the one or more computerized codes comprising:
a format supporting module operable to set programming languages supported by the 3D user interface;
a file embedding module operable to obtain an extensible 3D (X3D) file from the storage device, and embed the X3D file into a hypertext mark-up language (HTML) file using one of the set programming languages;
a browser plug-in operable to parse the X3D file in the HTML file, comprising performing a syntax check to the X3D file, and converting a statement format of the X3D file to a statement format that can be identified by a Web page browser of the 3D user interface;
a graphics library interface converting module operable to convert an open graphics library (Open GL) to an open graphics library for embedded systems (Open GL ES); and
a rendering module operable to execute corresponding functions in the Open GL ES according to parsing results from the browser plug-in, to render a 3D scene defined by the X3D file in the HTML file.

2. The embedded device as claimed in claim 1, wherein the embedded device further comprises a display, and the Web page browser of the 3D user interface is operable to output the HTML file with the 3D scene on the display.

3. The embedded device as claimed in claim 1, wherein the programming languages supported by the 3D user interface are the programming languages supported by the X3D standard.

4. The embedded device as claimed in claim 3, wherein the programming languages supported by the 3D user interface comprise virtual reality modeling language (VRML), extensible markup language (XML), JavaScript, Java, and Java3D.

5. The embedded device as claimed in claim 1, wherein the conversion comprises deleting functions in the Open GL, to create a flexible and powerful low-level 3D user interface between software and graphics acceleration in the embedded device.

6. The embedded device as claimed in claim 1, wherein the storage device is selected from the group consisting of a smart media card, a secure digital card, and a compact flash card.

7. The embedded device as claimed in claim 1, wherein the embedded device is selected from the group consisting of a mobile phone, a personal digital assistant, and a set-top box.

8. A there-dimensional (3D) user interface realization method in an embedded device, the method comprising:
setting programming languages supported by the 3D user interface;
obtaining an extensible 3D (X3D) file from a storage device of the embedded device, and embedding the X3D file into a hypertext mark-up language (HTML) file using one of the set programming languages;
parsing the X3D file in the HTML file, comprising performing a syntax check to the X3D file, and converting a statement format of the X3D file to a statement format that can be identified by a Web page browser of the 3D user interface;
converting an open graphics library (Open GL) to an open graphics library for embedded systems (Open GL ES); and
executing corresponding functions in the Open GL ES according to the parsing results, to render a 3D scene defined by the X3D file in the HTML file.

9. The method as claimed in claim 8, further comprising:
outputting the HTML file with the 3D scene on a display of the embedded device.

10. The method as claimed in claim 8, wherein the programming languages supported by the 3D user interface are the programming languages supported by the X3D standard.

11. The method as claimed in claim 10, wherein the programming languages supported by the 3D user interface comprise virtual reality modeling language (VRML), extensible markup language (XML), JavaScript, Java, and Java3D.

12. The method as claimed in claim 8, wherein the conversion comprises deleting functions in the Open GL, to create a flexible and powerful low-level 3D user interface between software and graphics acceleration in the embedded device.

13. The method as claimed in claim 8, wherein the storage device is selected from the group consisting of a smart media card, a secure digital card, and a compact flash card.

14. The method as claimed in claim 8, wherein the embedded device is selected from the group consisting of a mobile phone, a personal digital assistant, and a set-top box.

15. A non-transitory computer readable medium storing a set of instructions, the set of instructions capable of being executed by a microprocessor of an embedded device to perform a there-dimensional (3D) user interface realization method in the embedded device, the method comprising:
setting programming languages supported by the 3D user interface;
obtaining an extensible 3D (X3D) file from the non-transitory computer readable medium, and embedding the X3D file into a hypertext mark-up language (HTML) file using one of the set programming languages;
parsing the X3D file in the HTML file, comprising performing a syntax check to the X3D file, and converting a statement format of the X3D file to a statement format that can be identified by a Web page browser of the 3D user interface;
converting an open graphics library (Open GL) to an open graphics library for embedded systems (Open GL ES); and
executing corresponding functions in the Open GL ES according to the parsing results, to render a 3D scene defined by the X3D file in the HTML file.

16. The non-transitory computer readable medium as claimed in claim 15, wherein the method further comprises outputting the HTML file with the 3D scene on a display of the embedded device.

17. The non-transitory computer readable medium as claimed in claim 15, wherein the programming languages supported by the 3D user interface are the programming languages supported by the X3D standard.

18. The non-transitory computer readable medium as claimed in claim 17, wherein the programming languages supported by the 3D user interface comprise virtual reality modeling language (VRML), extensible markup language (XML), JavaScript, Java, and Java3D.

19. The non-transitory computer readable medium as claimed in claim 15, wherein the conversion comprises deleting functions in the Open GL, to create a flexible and powerful low-level 3D user interface between software and graphics acceleration in the embedded device.

20. The non-transitory computer readable medium as claimed in claim 15, wherein the non-transitory computer readable medium is selected from the group consisting of a smart media card, a secure digital card, and a compact flash card.
